(19) United States
(12) Patent Application Publication
(10) Pub. No.: US 2017/0180805 A1
(43) Pub. Date: Jun. 22, 2017

(54) Method and electronic device for video follow-play

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zhibing TU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,076

(22) Filed: Aug. 22, 2016

Related U.S. Application Data
(63) Continuation of application No. PCT/CN2016/089702, filed on Jul. 11, 2016.

(30) Foreign Application Priority Data
Dec. 22, 2015 (CN) 201510971568.2

(51) Int. Cl. H04N 21/466; H04N 21/25; H04N 21/433; H04N 21/258; H04N 21/45; H04N 21/231; H04N 21/8547; H04N 21/482

(52) U.S. Cl. CPC H04N 21/4668; H04N 21/8547; H04N 21/251; H04N 21/4826; H04N 21/25891; H04N 21/466; H04N 21/4532; H04N 21/23106; H04N 21/4331

(57) ABSTRACT

A video follow-play method and apparatus are provided. The method includes: acquiring video recommendation information directed to a user and history video play information of the user; setting, according to the video recommendation information and the history video play information, a video recommended to the user and played by the user as a video that needs follow-play; and updating a timestamp of the corresponding video when the video that needs follow-play is updated, and recommending the video of which the timestamp is updated to the user. According to the present disclosure, without establishing any update message notification mechanism and additionally storing updated video programs, a flexible and low-cost follow-play mechanism is implemented only by updating a timestamp of a video program.

### CROSS-REFERENCE TO RELATED APPLICATIONS

This application is a continuation of International Application No. PCT/CN2016/089702 submitted on Jul. 11, 2016, which is based upon and claims priority to Chinese Patent Application No. 201510971568.2, filed on Dec. 22, 2015, and entitled “METHOD AND SYSTEM FOR VIDEO FOLLOW-PLAY”, the entire contents of which are incorporated herein by reference.

### TECHNICAL FIELD

This disclosure relates to the field of multimedia technologies, and more particularly, to method and an electronic device for a video follow-play.

### BACKGROUND

With the constant development of, intelligent terminals and multimedia technologies, watching a video by using a video player or a video website has been accepted by most people. According to a current video program play manner, some latest video programs (for example, movies, television dramas, or variety shows) are played on a television or a terminal at intervals due to play time or other reasons. Therefore, a user cannot complete watching all episodes of the television programs at a time, and needs to search for latest episodes of the video programs for watching after the latest episodes occur. To enable the user to watch latest updated video programs in time, a recommendation apparatus in a television or terminal needs to recommend latest episodes to the user immediately after new episodes of some video programs are updated, that is, a video follow-play function.

However, currently, an implementation solution of the video follow-play function is complex, and a message update mechanism needs to be set to notify the recommendation apparatus of additionally storing updated video programs, and costs are increased. Moreover, when the user requests for recommendation, the recommendation apparatus usually recommends watched video programs to the user; consequently, the user obtains the same recommendation result when the user requests for recommendation each time, rather than the latest updated episode information that the user expects to obtain.

### SUMMARY

According to a first aspect, To achieve the above objective, an embodiment of the present disclosure provides a method for video follow-play, The method includes: acquiring video recommendation information directed to a user and history video play information of the user; setting, according to the video recommendation information and the history video play information, a video recommended to the user and played by the user as a video that needs follow-play; and updating a timestamp of the corresponding video when the video that needs follow-play is updated, and recommending the video of which the timestamp is updated to the user.

According to a second aspect, an embodiment of the disclosure further provides a non-volatile computer storage medium, which stores computer executable instructions, where the computer executable instructions can be executed to perform any one of the mentioned method for video follow-play of this disclosure.

According to a third aspect, an embodiment of the disclosure further provides an electronic device, including: at least one processor; and a memory in communication connection with the at least one processor. The memory stores instructions that can be executed by the at least one processor, and execution of the instructions by the at least one processor causes the at least one processor to perform any of the foregoing method for video follow-play of this disclosure.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

The accompanying drawings are used to provide further understanding of the present disclosure, to form a part of the specification. The accompanying drawings are used to explain the present disclosure together with the following specific embodiments, but do not construe a limitation to the present disclosure. In the accompanying drawings:

FIG. 1 is a schematic flowchart illustrating a method for video follow-play according to an embodiment of the present disclosure;

FIG. 2 is a schematic structural diagram illustrating an apparatus for video follow-play according to an embodiment of the present disclosure; and

FIG. 3 is a schematic structural diagram of hardware of a device for executing a method for video follow-play provided in an embodiment of this disclosure.

### DESCRIPTION OF THE SYMBOLS IN THE DRAWINGS

1 Acquiring unit

2 Setting unit

3 First recommendation unit

4 First storage unit

5 Second storage unit

6 Second recommending unit

21 Comparison subunit

22 Setting subunit

### DETAILED DESCRIPTION

Specific embodiments of the present disclosure are described hereinafter in detail with reference to the accompanying drawings. It should be understood that the specific embodiments described herein are merely used for describing and explaining the present disclosure, and are not intended to limit the present disclosure.

In the present disclosure, the terminal includes but is not limited to a smart mobile phone, a tablet computer, a palmtop computer, a vehicle-mounted intelligent device, or a wearable device. The recommendation apparatus refers to an apparatus integrated in a television or a terminal and used to recommend a video to a user, and is a conventional apparatus in the art.

In the art, when the user plays a program on a webpage or plays a program by using a video player, the recommendation apparatus in the television or the terminal first obtains video programs for recommendation to the user, and then the user selects, from the programs recommended by the recommendation apparatus, a program that the user is interested in for play. Therefore, a time point when the user watches the video program and the time point when the recommendation apparatus recommends the video program to the user are both later than a time point when the video program is provided for the recommendation apparatus. However, for an episode-type video program having updates, a time point when the video program is updated is later than a tine point when the user once watches the video program, and is earlier than a time point when the user watches updated episodes. Therefore, according to the present disclosure, by using different logical relationships between a timestamp of a video watched by a user and the video program before and after updates, video follow-play may be implemented, to recommend a video program that is once watched by the user and has latest episode updates to the user.

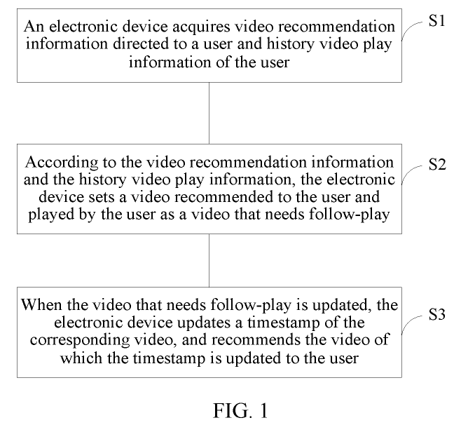

Specifically, an embodiment of the present disclosure provides a method for video follow-play. As illustrated in FIG. 1, the method includes the following steps:

In step S1: Video recommendation information directed to a user and history video play information of the user are acquired.

The history video play information includes information, for example, an anonymous ID of a user, a login ID of a user, a timestamp of a played video program, or duration of a played video. In this embodiment, the acquired history video play information is stored for a background to perform analysis, to master some characteristics of user play behaviors, for example, a user pays antenna to a star, or likes to watch American television dramas or action movies. Moreover, according to the history video play information, a recommendation apparatus can find a video program that is once watched by a user and has updates and recommend the video program to the user. The video recommendation information refers to information that is of recommending a video to a user and that is recorded by the recommendation apparatus, including information, for example, an anonymous ID of a user, a login ID of a user, or records of history recommended videos, where the video recommendation information reflects exposed behaviors of a user (that is, processing behaviors on history recommended videos, and a user may watch or may not watch videos recommended by the recommendation apparatus).

Moreover, after the history video play information of a user is acquired, this embodiment is preferred to caching the acquired history video play information in real time. In this way, any video play behavior of a user in a short term (for example, just now), for example, watching a video, can be fed back in real time immediately in next recommendation, and the video play behavior of a user does not need to be delivered to the background for feedback and recommendation after long-time analysis.

In step S2: According to the video recommendation information and the history video play information, a video recommended to the user and played by the user is set as a video that needs follow-play.

The step specifically includes: comparing the video recommendation information with the history video play information to determine the video recommended to the user and played by the user; and setting the determined video recommended to the user and played by the user as the video that needs follow-play.

User preference can be obtained by analyzing user play behaviors according to the history video play information, to set videos on which a user may need follow-play. With reference to the video recommendation information and the history video play information, a video recommended to a user before and a video played by the user before are selected, and a video that satisfies the two conditions at the same time is set as a video that need follow-play. Therefore, in this embodiment, follow-play is performed only on the video recommended to a user and played by the user, thereby avoiding recommending updated episodes of videos that the user is not interested in to the user and causing user antipathies.

It should be noted that, in this embodiment, videos that need follow-play do not need to be identified or set deliberately, and videos satisfying two conditions: being recommended to a user and being played by the user, need to be selected only according to the video recommendation information and the history video play information; in this way, all videos recorded in the history video play information may become videos on which a user needs follow-play.

However, too-short duration of video play cannot reflect preference of a user for the video, and long duration of play can reflect preference of a user for the video. Therefore, in this embodiment, the setting the determined video recommended to the user and played by the user as the video that needs follow-play further includes: according to the history video play information, acquiring a history play duration of the determined video recommended to the user and played by the user; and setting the video of which the history play duration exceeds a given threshold as the video that needs follow-play. The threshold may be set with reference to user habits herein.

In step S3: When the video that needs follow-play is updated, a timestamp of the corresponding video is updated, and the video of which the timestamp is updated is recommended to the user.

Monitoring, by the recommendation apparatus, whether a video is updated is a mature technology in the art, for example, video information and update information of the video can be grabbed from a corresponding webpage according to a URL of the video to be monitored. The update information includes an update state and update time of the video, corresponding starting and ending timestamps after the video is updated, and the like.

According to the different logical relationships between a timestamp of a video watched by a user and the video program before and after updates, in this embodiment, a timestamp of a video that needs follow-play is updated based on update information after the video is updated; after the timestamp is updated, the recommendation apparatus can sense that the video program has latest episode updates, to recommend the video program to a user.

The video after the timestamp is updated is latest episodes; the recommendation apparatus recommends a play link of the latest episodes to a user; the user clicks the link; according to the updated timestamp, the video starts to play from starting time indicated in the timestamp, to implement follow-play.

Moreover, manners for recommending a video to a user are categorized into an automatic recommendation manner and a user-request-based recommendation manner; the former is that after sensing video updates, the recommendation apparatus automatically recommends the updated video to a user, while the latter is that a user sends a request for requesting the recommendation apparatus to recommend a video, and then the recommendation apparatus decides by itself whether to perform recommendation.

Further, in addition to the manner of updating a timestamp, in this embodiment, a message update mechanism can be established to recommend updated videos to a user in a manner of storing, by the recommendation apparatus, video programs that have latest updates.

The above steps implement video follow-play. However, when a user initiates a recommendation request again after seeing a result of last recommendation (manners for sending the recommendation request include refreshing an interface, and the like), if a video indicated in the recommendation request has no updates, the recommendation apparatus may recommend the recommendation result seen by the user to the user again; consequently, the recommendation apparatus returns the same video program, thereby affecting user experience.

To resolve the problem, the method for video follow-play of this embodiment further includes the following steps: storing, in real time, a recommendation result of recommending the video to the user; and after it is detected that the user initiates a recommendation request based on the recommendation result, if the video that needs follow-play is updated, recommending the video of which the timestamp is updated to the user, and if the video that needs follow-play is not updated, not recommending the corresponding video in the recommendation result to the user. The recommendation result records video programs recommended by the recommendation apparatus to each user, and reflects user exposed behaviors. Therefore, the above processing avoids, when the user sends a recommendation request again after seeing the result of last recommendation, returning a video the same as the result of last recommendation to the user because the video is not updated.

Further, when the recommendation result is stored, information, for example, a user anonymous ID, a user login ID, or timestamps of exposed video programs, involved in the user exposed behaviors are stored together, and written into the video recommendation information, to avoid, more accurately, returning a video program the same as the result of last recommendation to the user in next recommendation.

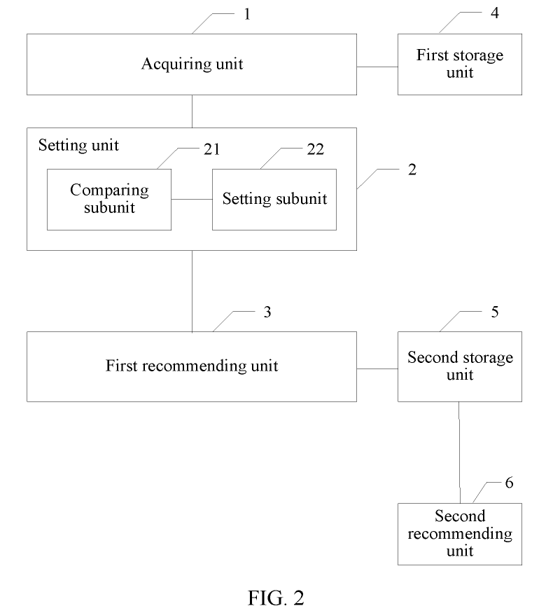

Based on an inventive principle the same as that of the above method for video follow-play, another embodiment of the present disclosure further provides an apparatus for video follow-play. The apparatus is equivalent to a recommendation apparatus, and further implements video follow-play by using video recommendation information and history video play information that are recorded by an original recommendation apparatus. As illustrated in FIG. 2, the apparatus includes: an acquiring unit 1, a setting unit 2, and a first recommending unit 3. The acquiring unit 1 acquires video recommendation information directed to a user and history video play information of the user; the setting unit 2 sets, according to the video recommendation information and the history video play information, a video recommended to the user and played by the user as a video that needs follow-play; and the first recommending unit 3, updates a timestamp of the corresponding video when the video that needs follow-play is updated, and recommends the video of which the timestamp is updated to the user.

The setting unit 2 includes: a comparing subunit 21, and a setting subunit 22. The comparing subunit 21 compares the video recommendation information with the history video play information to determine the video recommended to the user and played by the user; and the setting subunit 22 sets the determined video recommended to the user and played by the user as the video that needs follow-play. Wherein, the setting subunit 22 further acquires, according to the history video play information, a history play duration of the determined video recommended to the user and played by the user; and sets the video of which the history play duration exceeds a given threshold as the video that needs follow-play.

Moreover, the apparatus further includes: a first storage unit 4, a second storage unit 5, and a second recommending unit 6. The first storage unit 4 caches, in real time, the history video play information acquired by the acquiring unit; the second storage unit 5, stores, in real time, a recommendation result of recommending the video to the user; and the second recommending unit 6, detects that the user initiates a recommendation request based on the recommendation result, if the video that needs follow-play is updated, recommends the video of which the timestamp is updated to the user, and if the video that needs follow-play is not updated, not recommends the corresponding video in the recommendation result to the user.

The functional units and functional subunits in the apparatus of this embodiment correspond to corresponding steps of the method for video follow-play in last embodiment, and specific implementation process of the apparatus is also same as or similar to that of the method for video follow-play, and therefore details are not described herein again.

In summary, the method and apparatus for video follow-play disclosed in the embodiments of the present disclosure have the following advantages:

1) history video play information and video recommendation information that are acquired and recorded by a recommendation apparatus itself are used so that extra development overheads are reduced;

2) any mechanism does not need to be established to notify the recommendation apparatus of any episode update of video programs; the recommendation apparatus does not need to additionally store the video programs having updated new episodes; only timestamps of the video programs need to be updated; the manner of completing video update by using a timestamp and performing recommendation implements a flexible and low-cost follow-play manner; and

3) when a user initiates a recommendation request according to a result of last recommendation, a case of sending a video the same as the result of last recommendation to the user when the video is not updated is avoided.

Correspondingly, an embodiment of this disclosure provides a non-transitory computer-readable medium, which stores computer executable instructions, where the computer executable instructions can be executed to perform the method for video follow-play in any one of the foregoing method embodiments.

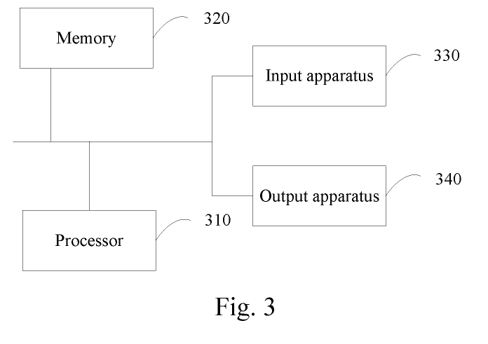

Correspondingly, FIG. 3 is a schematic structural diagram of hardware of an electronic device for executing a method for video follow-play provided in an embodiment of this disclosure. As shown in FIG. 3, the electronic device includes: one or more processors 310 and a memory 320, where only one processor 310 as an example in FIG. 3.

The electronic device for executing the method for video follow-play may further include: an input apparatus 330 and an output apparatus 340.

The processor 310, the memory 320, the input apparatus 330, and the output apparatus 340 can be connected by means of a bus or in other manners. A connection by means of a bus as an example in FIG. 3.

As a non-transitory computer-readable storage medium, the memory 320 can be used to store non-transitory software programs, non-transitory computer-readable executable programs and modules, for example, a program instruction/module corresponding to the method for video follow-play in the embodiments of this disclosure (for example, the acquiring unit 1, the setting unit 2, the first recommendation unit 3, the first storage unit 4, the second storage unit 5, the second recommendation unit 6, the comparison subunit 21, and the setting subunit 22 shown in FIG. 2). The processor 310 executes various functional disclosures and data processing of the server, that is, implements the method for video follow-play of the foregoing method embodiments, by running the non-transitory software programs, instructions, and modules that are stored in the memory 320.

The memory 320 may include a program storage area and a data storage area, where the program storage area may store an operating system and an disclosure that is needed by at least one function; the data storage area may store data created according to use of the apparatus for video follow-play, and the like. In addition, the memory 320 may include a high-speed random access memory, or may also include a non-transitory memory such as at least one disk storage device, flash storage device, or another non-transitory solid-state storage device. In some embodiments, the memory 320 optionally includes memories that are remotely disposed with respect to the processor 310, and the remote memories may be connected, via a network, to the apparatus for video follow-play. Examples of the foregoing network include but are not limited to: the Internet, an intranet, a local area network, a mobile communications network, or a combination thereof.

The input apparatus 330 can receive entered digits or character information, and generate key signal inputs relevant to user setting and functional control of the apparatus for video follow-play. The output apparatus 340 may include a display device, for example, a display screen.

The one or more modules are stored in the memory 320, and execute the video recommending method in any of the method for video follow-play embodiments when being executed by the one or more processors 310.

The foregoing product can execute the method provided in the embodiments of this disclosure, and has corresponding functional modules for executing the method and beneficial effects. The method provided in the embodiments of this disclosure can be referred to for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A method for video follow-play, applied in an electronic device, wherein the method comprises:
acquiring video recommendation information directed to a user and history video play information of the user;
setting, according to the video recommendation information and the history video play information, a video recommended to the user and played by the user as a video that needs follow-play; and
updating a timestamp of the corresponding video when the video that needs follow-play is updated, and recommending the video of which the timestamp is updated to the user.

2. The method according to claim 1, wherein upon the acquiring history video play information of the user, the method further comprises: caching the acquired history video play information in real time.

3. The method according to claim 1, wherein the setting, according to the video recommendation information and the history video play information, a video recommended to the user and played by the user as a video that needs follow-play comprises:
comparing the video recommendation information with the history video play information to determine the video recommended to the user and played by the user; and
setting the determined video recommended to the user and played by the user as the video that needs follow-play.

4. The method according to claim 3, wherein the setting the determined video recommended to the user and played by the user as the video that needs follow-play comprises:
acquiring, according to the history video play information, a history play duration of the determined video recommended to the user and played by the user; and
setting the video of which the history play duration exceeds a given threshold as the video that needs follow-play.

5. The method according to claim 1, further comprising:
storing, in real time, a recommendation result of recommending the video to the user; and
after it is detected that the user initiates a recommendation request based on the recommendation result, if the video that needs follow-play is updated, recommending the video of which the timestamp is updated to the user, and if the video that needs follow-play is not updated, not recommending the corresponding video in the recommendation result to the user.

6. A non-transitory computer-readable storage medium, which stores computer executable instructions that, when executed by an electronic device, cause the electronic device to:
acquire video recommendation information directed to a user and history video play information of the user;
set, according to the video recommendation information and the history video play information, a video recommended to the user and played by the user as a video that needs follow-play; and
update a time stamp of the corresponding video when the video that needs follow-play is updated, and recommend the video of which the time stamp is updated to the user.

7. The non-transitory computer-readable storage medium according to claim 6, wherein upon the acquiring history video play information of the user, the electronic device is further caused to: cache the acquired history video play information in real time.

8. The non-transitory computer-readable storage medium according to claim 6, wherein the instructions to set, according to the video recommendation information and the history video play information, a video recommended to the user and played by the user as a video that needs follow-play further cause the electronic device to:
compare the video recommendation information with the history video play information so as to determine the video recommended to the user and played by the user; and
set the determined video recommended to the user and played by the user as the video that needs follow-play.

9. The non-transitory computer-readable storage medium according to claim 8, wherein the instructions to set the determined video recommended to the user and played by the user as the video that needs follow-play cause the electronic device to:
acquire, according to the history video play information, history play duration of the determined video recommended to the user and played by the user; and
set the video of which the history play duration exceeds a given threshold as the video that needs follow-play.

10. The non-transitory computer-readable storage medium according to claim 6, wherein the electronic device is further caused to:
store, in real time, a recommendation result of recommending the video to the user; and
after it is detected that the user initiates a recommendation request based on the recommendation result, if the video that needs follow-play is updated, recommend the video of which the time stamp is updated to the user, and if the video that needs follow-play is not updated, not recommend the corresponding video in the recommendation result to the user.

11. An electronic device, comprising:
at least one processor; and
a memory communicably connected with the at least one processor for storing instructions executable by the at least one processor, wherein execution of the instructions by the at least one processor causes the at least one processor to:
acquire video recommendation information directed to a user and history video play information of the user;
set, according to the video recommendation information and the history video play information, a video recommended to the user and played by the user as a video that needs follow-play; and
update a time stamp of the corresponding video when the video that needs follow-play is updated, and recommend the video of which the time stamp is updated to the user.

12. The electronic device according to claim 11, wherein upon the acquiring history video play information of the user, the at least one processor is further caused to: cache the acquired history video play information in real time.

13. The electronic device according to claim 11, wherein the execution of the instructions to set, according to the video recommendation information and the history video play information, a video recommended to the user and played by the user as a video that needs follow-play causes the at least one processor to:
compare the video recommendation information with the history video play information to determine the video recommended to the user and played by the user; and
set the determined video recommended to the user and played by the user as the video that needs follow-play.

14. The electronic device according to claim 13, wherein the execution of the instructions to set the determined video recommended to the user and played by the user as the video that needs follow-play causes the at least one processor to:
acquire, according to the history video play information, history play duration of the determined video recommended to the user and played by the user; and
set the video of which the history play duration exceeds a given threshold as the video that needs follow-play.

15. The electronic device according to claim 11, wherein the at least one processor is caused to:
store, in real time, a recommendation result of recommending the video to the user; and
after it is detected that the user initiates a recommendation request based on the recommendation result, if the video that needs follow-play is updated, recommend the video of which the time stamp is updated to the user, and if the video that needs follow-play is not updated, not recommend the corresponding video in the recommendation result to the user.
